(19) United States
(12) Patent Application Publication
(10) Pub. No.: US 2003/0048762 A1
(43) Pub. Date: Mar. 13, 2003

(54) Seamless integrated network system for wireless communication systems

(76) Inventors: Gang Wu, Tokyo (JP); Khaled Mahmud, Tokyo (JP); Mitsuhiko Mizuno, Tokyo (JP); Yoshihiro Hase, Tokyo (JP)

Correspondence Address: BIRCH STEWART KOLASCH & BIRCH, PO BOX 747, FALLS CHURCH, VA, 22040-0747, US

(21) Appl. No.: 10/091,578

(22) Filed: Mar. 7, 2002

(30) Foreign Application Priority Data
Sep. 7, 2001 (JP) 2001-272660

(51) Int. Cl. H04Q 7/00; H04L 12/66

(52) U.S. Cl. 370/328; 370/352

(57) ABSTRACT

To create a network that connects a plurality of radio systems to create optimal systems for various environments, and that seamlessly integrates the resulting systems together in order to provide more efficient and advanced service in general. A basic access network 11 enables communication 13 between a basic access component provided in a mobile host 10 and widely disposed basic access network base stations, and comprises a basic access network channel implemented with a two-way radio interface and a basic access network protocol also used by a common core network of the network system.

### FIELD OF THE INVENTION

The present invention relates to a system that seamlessly integrates various wireless communication systems to increase efficiency. In particular, the present invention relates to the architecture of this system.

### BACKGROUND OF THE INVENTION

Despite the all-out efforts for convergence of wireless systems at various levels, there exit and there will exit various mobile systems, which have conflicting operation from both technical (e.g. frequency band, air interface, etc.) and business (e.g. deployment, penetration, etc.) point of view, even though they may provide essentially similar services from a user point of view (e.g. voice, multimedia, etc.).

Because of the similarity of the services these mobile systems provide, a large portion of their backbone infrastructure has to maintain similar facilities or functionalities. For instance, all the wireless mobile systems have to maintain location registers. In a future wireless integrated environment where a user will be allowed (or rather be encouraged) to access and roam around various systems, a huge amount of traffic will be generated due to the repetitive execution of functions like location query/update, authentication, etc. at each system access points and cross-system interfaces.

With the introduction of newer systems and services this problem will aggravate and the maintenance and upgrade will become virtually impossible at some point. Moreover, a user may have to maintain multiple difficult-to-remember identifications numbers (ID) of all the systems he or she wants to use.

A natural solution to such a situation seems to be the introduction of a basic access network or system, which will coordinate the multitude of diverse systems (of final services), providing a common backbone infrastructure and a common control channel with a universally agreed upon protocol for inter-system dialog.

Such a system will allow the user to maintain only one ID to access the minimum services of the integrated wireless network environment. This will also enable personal mobility of the user and free the service networks from the responsibility of maintaining mobility management entities (e.g. HLR, VLR, etc.) individually. It is an object of the present invention to provide a seamless integrated network system for radio systems comprising a basic access network and a common core network that solves the above conventional problems.

### BRIEF DESCRIPTION OF THE DRAWINGS

FIG. 1 is an explanatory diagram of the elements constituting a BAN and an integrated network;

FIG. 2 is a schematic view of a software-defined radio (SDR) mobile host incorporating a basic access component;

FIG. 3 shows the architectural relationship between elements of a BAN, a common core network, or another RAN, as well as various interfaces;

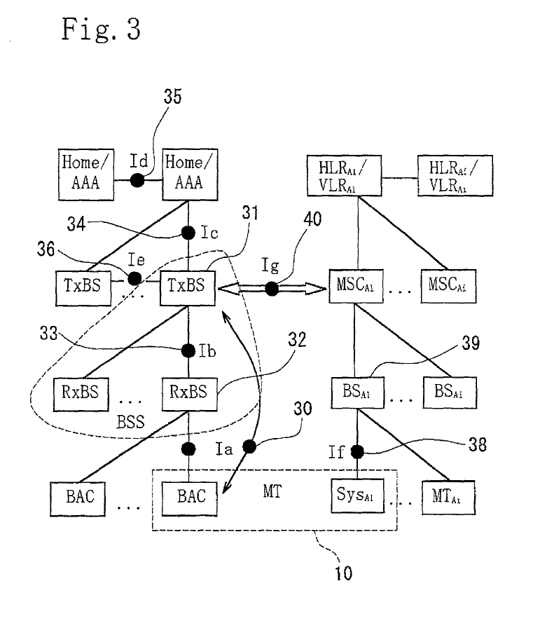

FIG. 4 is a table showing trial link values for a 280-MHz band and an 850-MHz band;

FIG. 5 is a table showing propagation distances in different areas.

Identification of reference numerals used in the drawings is as follows: 10 Mobile Host, 11 Basic Access Network according to Present Invention, 12 Service Networks, 13 Arrow Indicating Radio Communication between Mobile Host and Basic Access Network, 14 Arrow Indicating Radio Communication between Mobile Host and Both Service Networks, 15˜16 Arrow Indicating that BAN and Service Network Communicate with Each Other via Common Core Network.

### DESCRIPTION OF THE PREFERRED EMBODIMENTS

To achieve the above object, the present invention uses the following means:

In a network system that seamlessly integrates radio systems, a basic access network enables communication between a basic access component provided in a mobile host and widely deployed basic access network base stations, and comprises a basic access network channel implemented with a two-way radio interface and a basic access network protocol to communicate with the common core network or the rest of the integrated network.

A mobile host in the basic access network comprises either only a basic access component, or comprises the basic access component as well as a radio module that can be connected to at least two other radio systems, a locator, a controller, and a user interface.

The basic access component is formed by software radio or hardware. The basic access network may have transmission base stations and reception base stations disposed therein. Each of the transmission base stations transmits downlink data to the basic access component provided in the mobile host located in an area within a radius of several to several tens of kilometers of the transmission base station, and each of the reception base stations receives uplink data from the basic access component provided in the mobile host located in an area within a radius of several to several tens of kilometers of the reception base station.

The basic access network may have at least one, a combination, or all of the following: functions for invoking said mobile host, functions for processing a notification of locational information from said communication terminal, functions for notifying said mobile host of information based on the locational information and required to find a radio system, and functions for supporting minimum information required by the mobile host to perform handover with a heterogeneous radio system.

An embodiment of the present invention will be described below with reference to the drawings.

In the present invention, future wireless networks providing high-speed data and multimedia services are expected to be connected through a managed IPv6 based common core network. The users can access any of the systems that he subscribed for and can smoothly move around across the networks. The individual networks can be overlapping with each other.

The basic access network is to be laid over all the constituent networks of the integration according to the present invention. Using the common signaling packets of the basic access network, the users can access any of the service systems and can smoothly move around across the overlapped service systems.

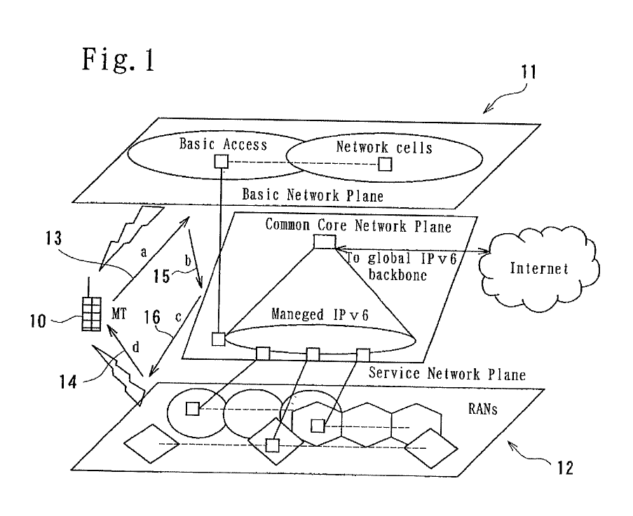

The architectural relationship with the core network and the service networks is depicted in FIG. 1. As shown in FIG. 1, the mobile terminal (10) makes wireless communication with both the BAN (11) and service networks (12) (arrows a (13) and d (14)), while the BAN (11) and the service networks (12) communicate through the Common Core Network (arrows b (15) and c (16)).

In subsequent sections the physical and logical features of BAN in relation with the integrated networks are elaborated.

The operation of Basic Access Network in the integrated networks will necessitate three main logical components, namely (a) the set of BAN Component (BAC) in the mobile terminals, and extensively deployed BAN base stations (BS), (b) a BAN CHannel (BACH) which is implemented together with a special two-way radio interface, and which is independent of a radio interface for accessing the service network, and (c) a BAN Protocol (BAP) specially developed for the implementation of the interfaces between the BAN and the Common Core Network (CCN) (M. Hasegawa, H. Murakami, G. Wu. M. Mizuno, “Multimedia Integrated network by Radio Access Innovation (MIRAI): (4) Common Core Network”, to appear in IEICE General Conf., March, 2001) of MIRAI (FIG. 1).

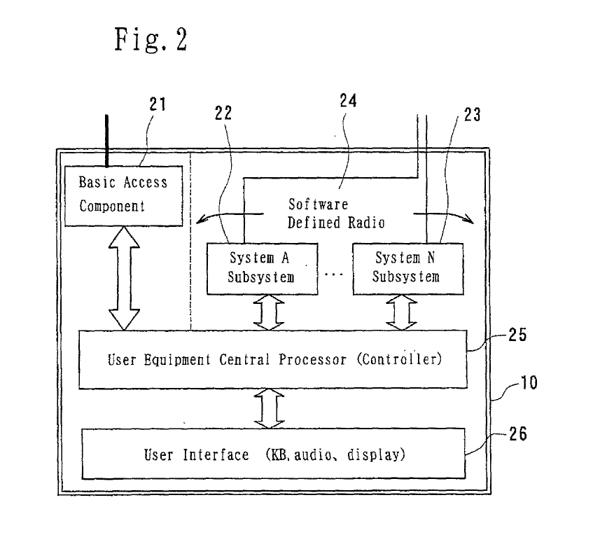

The user of the integrated networks may possess (or use) multiple single service (system) terminals or a multi-service terminal. But his identity to the network should remain unambiguous. FIG. 2 illustrates an image of user equipment (i.e. mobile host). (We will use the terms ‘user equipment’, ‘user terminal’ and ‘mobile terminal’ interchangeably, as appropriate to emphasize the context).

As shown in the FIG. 2, user equipment (10) will contain a Basic Access Component (21) to communicate with the Basic Access Network (11). There will be one or more subsystems (22), (23) for accessing (communicating with) the subscribed service systems or Radio Access Networks (RAN).

These subsystems (22), (23) are indicated as system A (22), . . . , system N (23). Only one of these will be in operation at a time, depending on which service the user is accessing currently. Implementation of software defined radio (SDR) (24) seems to the most demanding choice to accommodate a number of such subsystems (22), (23) in a terminal.

All the air access subsystems (including the Basic Access Component) will be equipped with all necessary components to operate independently with the corresponding air interfaces. The inbound (outbound) data will be delivered to (received from) the user equipment Central Processor (CP) (25).

The Central Processor (25) will coordinate all the operations within the user equipment. For example, it will handle the user interface (26), monitor channel condition, configure and switch between service subsystems, etc.

In the following, we aggregate the main responsibilities of the BAN in some major groups of functionalities.

(i) User Profile Management: The BAN will maintain databases for keeping various information about the user (e.g. Authentication and Authorization Matrix, Active Device Profile, Service Preference Order, Service Usage Log, Incoming Call Filter, Automatic Answer Message Table, etc.). The user can access these databases from the BAC in standalone mode (i.e. using BACH only), or from the host terminal (i.e. using any RAN) for better browsing.

(ii) Home Location Management: The BAN will provide the home location for the subscribers who are not specifically subscribed to any other RAN and received a home address. In the context of IP, the BAN should provide home agent service to the mobile users.

(iii) Geo-Positioning Management: The BAN component BAC can report locational information by cooperating with a locator (e.g., a GSP component) comprising a positioning function. Using location data from BAC, the network will keep track of the roaming users in the locations registers that belong exclusively to BAN. The BAN should manage primary position information in terms of latitude, longitude and elevation to the user. This position information can be used for service search, basic navigation, disaster call etc.

(iv) Service Brokerage Management; While the user initiates a service access for a particular RAN, BAN will perform all the necessary contacts with respective RAN agents. When the user wants to access a service from a particular provider to whom the user is not explicitly subscribed, the BAN will act as the broker to negotiate a temporary service for the user.

(v) Broadcast Service: The base stations of the network will maintain a broadcast channel. Through this broadcast channels (or when solicited, through a dedicated channel), the network will provide the user with network accessibility and availability related information for the specific location of the user. The broadcast channel can also transmit other useful information particular to the region of coverage.

(vi) Security Association Management: The BAN, being the only common system to both the users and all RANs, should also manage all the bilateral and multilateral security associations with the mobility agents of CCN to establish AAA requirements and protocols.

(vii) Deployment Information Management; The BAN should maintain updated information about the deployment topology of the service systems. This will enable the user to avail of the latest services and to optimize the choice of services.

Having described the responsibilities of the BAN, here we will illustrate some basic operational procedure of the Basic Access Component embedded into the mobile terminal. While kept powered, the BAC will continue to be tuned to the base station transmitter to receive the broadcast channel and to be able to transmit when necessary. The BAC will be involved in active sessions of communication with the base station in the following occasions.

(i) Location Update: When crossing the boundary between paging areas, when the user starts to access the service network, when carrying out handover between heterogeneous networks, or when changing the service network according to the user's will, the BAC transmits its physical locational information to the network to facilitate location management and service/resource optimization. This will also enable the network to deliver calls to the mobile terminal when the latter is not actively attached to any RAN.

(ii) Access Initiation: When the user initiates access to a service network, BAC will send a packet to BAN, requesting to perform the service negotiation with the target RAN if it is available in the area of question. This packet will contain authentication information and other necessary data for negotiation. In return, the base station will send a packet with acceptance (or rejection) with the available service profile. BAC will pass this information to Central Processor of the mobile terminal.

(iii) Handoffs between Heterogeneous Systems: The BAC improves the efficiency of handoffs between heterogeneous systems. Transmission of locational information by the BAC facilitates the discovery of the optimum system as a handoff destination.

(iv) Call Receive: It Is through BAC that the mobile terminal will be informed about an incoming call. If the user decides to receive a call, BAC will initiate the RAN access as in (ii).

The main objective of the BAN to provide a common control/signaling channel for all the participant networks while a user initiate an access to any network or when a call arrives targeted for the user. Since BAN will be used mostly at the time of establishing new service connections (and periodic locations updates), a relatively low-speed/bit rate two-way data communication channel between the mobile terminal and the network would suffice.

However the channel should be highly reliable, given the fact that without the establishment of this channel, the user would be unable to access any RAN service. Similarly, since access to any RAN service is dependent on the access to the BAN, the wide coverage of BAN is key to the implementation of the integrated wireless networks.

However, the BAC embedded in the mobile terminal will obviously be a tiny component with limited power and computational capacity. To embed such a component in every mobile terminal of future generation, it should be also be optimized for simplicity and low cost.

Therefore our main design objective will be to maximize access reliability and coverage, keeping in mind the constrains of power, size, antenna gain, bandwidth, processing/storage capacity, etc of the mobile terminal, the requirement large deployment base to provide contiguous coverage for all available service systems, and competitive edge.

We should consider these parameters in designing a network of optimal cell coverage and reliability as demanded by the required characteristics of such a pivotal network.

Because of the power limitation of the mobile terminal, it is not possible to have very large cell size. However, it would not be very practical to deploy so many base stations required for the coverage of all the areas where any RAN service is available.

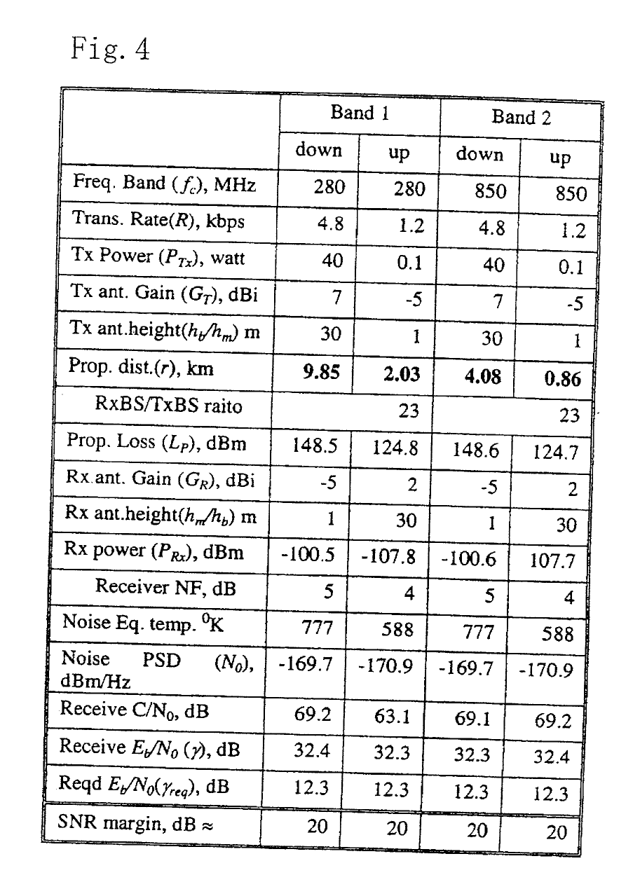

The link-budget estimate in FIG. 4 shows some candidate parameters of the uplink and downlink channels in the frequency band of 280 MHz and 850 MHz (Y. Hase, K. Okada and G. Wu, “A novel mobile basic access system using Mobile Access Signaling Card On Telecommunication systems (MASCOT)”, Tech. Report of IPSJ, Vol. 97, No. 72, pp. 37-42, July 1997). We are assuming non-coherent FSK modulation without any forward error correction (FEC) scheme. The required SNR values are meant for the BER of 10⁻⁴.

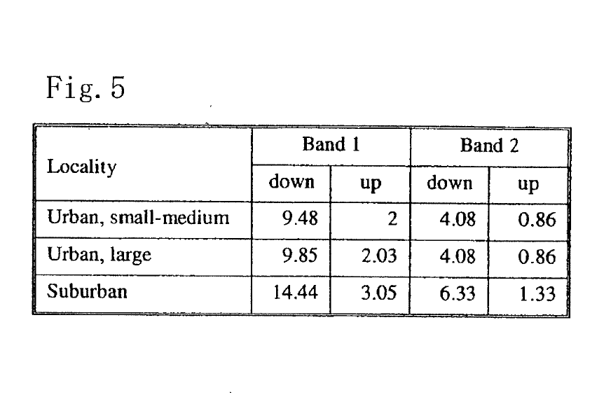

We considered three deployment scenarios according to Hata model (M. Hata, “Empirical Formula for propagation Loss in Land Mobile Services”, IEEE Transactions on Vehicular Technology Vol. VT-29, No. 3, pp. 317-325, August 1980): suburban, small-medium urban and large urban. FIG. 4 corresponds to large urban area model. Propagation distance for other models are tabulated in Table 5. It is to be noted that the ratio of required number of RxBS (32) and TxBS (31) is approximately 23 and this number is constant for all the model since we kept the required SNR margin same. The quantities in FIG. 5 indicates that 280 MHz band, as expected, is a much better choice for implementing BAN.

It should be recognized that various variables play their roles in determining the link budget of the channel, hence the design can be optimized in various ways. For example, with DSP based implementation, the BAC can use multi-level modulation (e.g. QAM) or coding to optimize signal strength (reliability vs. coverage), battery usage, access delay, etc. Also, using non-linear techniques, deployment topology of base stations can be optimized for cost effective efficient radio coverage.

The present invention enables the construction of a network that utilizes multiple types of radio systems in a manner optimal for their environments, while seamlessly integrating such systems to provide more efficient and advanced network services in general.

What is claimed is:

1. A network system that seamlessly integrates radio systems, the system being characterized in that a basic access network enables communication between a basic access component provided in a mobile host and widely deployed basic access network base stations, and
comprises a basic access network channel implemented with a two-way radio interface; and
a basic access network protocol to communicate with the common core network or-the rest of the integrated network.

2. A seamless integrated network system for radio systems according to claim 1, characterized in that a mobile host in said basic access network comprises:
only a basic access component, or comprises the basic access component, as well as
a radio module that can be connected to at least two other radio systems, a locator, a controller, and a user interface, and
the basic access component is formed by software radio or hardware.

3. A seamless integrated network system for radio systems according to claim 1, characterized in that:
said basic access network has transmission base stations and reception base stations disposed therein;
each of said transmission base stations transmits downlink data to the basic access component provided in the mobile host located in an area within a radius of several to several tens of kilometers of the transmission base station, and
each of said reception base stations receives uplink data from the basic access component provided in the mobile host located in an area within a radius of several to several tens of kilometers of the reception base station.

4. A seamless integrated network system for radio systems according to claim 2, characterized in that:
said basic access network has transmission base stations and reception base stations disposed therein;
each of said transmission base stations transmits downlink data to the basic access component provided in the mobile host located in an area within a radius of several to several tens of kilometers of the transmission base station, and
each of said reception base stations receives uplink data from the basic access component provided in the mobile host located in an area within a radius of several to several tens of kilometers of the reception base station.

5. A seamless integrated network system for radio systems according to claim 1, characterized in that:
said basic access network has at least one, a combination, or all of:
a function for invoking said mobile host;
a function for processing a notification of locational information from said communication terminal;
a function for notifying said mobile host of minimum information based on the locational information and required to find a radio system; and
a function for supporting minimum information particularly required by the mobile host to perform handover with a heterogeneous radio system.

6. A seamless integrated network system for radio systems according to claim 2, characterized in that:
said basic access network has at least one, a combination, or all of:
a function for invoking said mobile host;
a function for processing a notification of locational information from said communication terminal;
a function for notifying said mobile host of minimum information based on the locational information and required to find a radio system; and
a function for supporting minimum information particularly required by the mobile host to perform handover with a heterogeneous radio system.

7. A seamless integrated network system for radio systems according to claim 3, characterized in that:
said basic access network has at least one, a combination, or all of:
a function for invoking said mobile host;
a function for processing a notification of locational information from said communication terminal;
a function for notifying said mobile host of minimum information based on the locational information and required to find a radio system; and
a function for supporting minimum information particularly required by the mobile host to perform handover with a heterogeneous radio system.

8. A seamless integrated network system for radio systems according to claim 4, characterized in that:
said basic access network has at least one, a combination, or all of:
a function for invoking said mobile host;
a function for processing a notification of locational information from said communication terminal;
a function for notifying said mobile host of minimum information based on the locational information and required to find a radio system; and
a function for supporting minimum information particularly required by the mobile host to perform handover with a heterogeneous radio system.
